(19) United States
(12) Patent Application Publication
(10) Pub. No.: US 2017/0111087 A1
(43) Pub. Date: Apr. 20, 2017

(54) Method to Wirelessly Transfer Electricity between Cellular Phones

(71) Applicant: Jonathan Perry Williamson, Alpharetta, GA (US)

(72) Inventor: Jonathan Perry Williamson, Alpharetta, GA (US)

(21) Appl. No.: 14/886,075

(22) Filed: Oct. 18, 2015

(51) Int. Cl. H04B 5/00; H02J 50/90; H02J 7/02; H02J 50/12

(52) U.S. Cl. CPC H04B 5/0037; H02J 50/12; H02J 50/90; H02J 7/025

(57) ABSTRACT

Over the last few decades there has been major innovation in devices that use electricity (cell phones, computers, tablets, televisions), however, there has been little innovation in the mobility and accessibility of electricity itself on the small scale. At the moment, electricity is generally non-transferable on a personal level—if two individuals had cellphones, one at 100% and another at 0%, they could not share the available power between them. The present invention offers a solution to the issue of transferring electricity between cellular devices which enables electricity to be sharable and transferable in small scale daily situations.

PRIOR ART:

| | | |
|---|---|---|
| US 20080116847 A1 | May 22, 2008 | Lee, Loke, Raif |
| WO 2008026080 A2 | Mar. 6, 2008 | Hua, Ling, Raif |
| U.S. Pat. No. 8,898,485 B2 | Nov. 25, 2014 | Scott, Hodges |
| WO 2009131990 A2 | Oct. 29, 2009 | Nigel Power Llc |
| WO 2012085119 A3 | Oct. 11, 2012 | Elo |

TITLE: A Methond to Wirelessly Transfer Electricity between Cellular Phones

### FIELD OF INVENTION

The present invention relates to wirelessly transferring electrical energy between cell phones using the concept of inductive coupling. More particularly, a transmitter and receiver circuits are connected either internally or externally to cellular devices so electrical energy can be wirelessly transferred between cellphones through inductive coupling.

### BACKGROUND OF INVENTION

Historically, one of the major points for innovation in technology is customer convenience. Personal computers, tablets, and cell phones were all invented because they enabled data such as pictures, music, videos, and games to be convenient to consumers. While there has been significant innovation over the last few decades in devices that use electricity, there has been very little innovation regarding the accessibility and mobility of electricity itself In 2005, a study by researchers at the Massachusetts Institute of Technology (MIT) showed that electricity can be wirelessly transferred short distances by using resonant coupling. From this study inventions such as the wireless charging pad were created. This device made electricity more convenient by eliminating the necessity for power cords. Although the discovery made by MIT made charging electronic devices more convenient, it did not enable electricity to be transferable or sharable. This invention would enable electricity to be transferable and shareable.

### SUMMARY OF THE INVENTION

The present invention provides a method to transfer electricity between cellular devices. This device differs from current wireless transfer devices because it enables electricity to be transferred between two direct current power sources. Most wireless charging pad are powered by an alternating power source. This invention differs other patented wireless electrical energy transfer devices because of both its simplicity and the fact that it enables electricity to be transfer between direct current powered devices. The present invention offers enable electricity to me a transferable and shareable on a small scale. The present invention applies but is not limited to cell phones, laptops, and any electrical device powered by a direct current source.

The present invention works by using inductive coupling. Inductive coupling circuits consist of a set of two coils: the transmitter coil and the receiver coil. When alternating current (AC) flows from the power source to the transmitter coil, a magnetic field is formed. The alternating nature of the current causes the magnetic field to oscillate/change (the current constantly changes direction causing the magnetic field to change) (Wilson). This changing magnetic field is picked up by the receiver coil and current flows through it due to Faraday's Law—anytime there is a change in a magnetic field, current is produced (Wirelesspowerconsortium.com). Direct current (DC) cannot be used to power the transmitter coil because while a magnetic field will be produced, no current will be generated because the magnetic field does not oscillate following the principle of Faraday's Law (Wirelesspowerconsortium.com). Since cell phone batteries are a direct current power source, a circuit device must be created to convert the direct current to alternating current. This circuit will consist of MOSEFTs (metal-oxide-semiconductor field-effect transistor), diodes, capacitors, and resistors. The MOSEFT is the most critical component of this circuit since it is the part that converts the direct current to alternating current. MOSEFTs consist of a Gate, Drain, and Source. The Source is how power/current enters the MOSEFT and the Drain is how the current exits the MOSEFT. The Gate separates the Source and the Drain and acts like a switch. When current flows to the Gate (isn't a continuous flow), it connects the Source and Drain. Hence when current flows again to the Gate, it causes the path between the Source and Drain to open (Talkingelectronics.com). By the circuit uniformly opening and closing the Gate, it causes oscillation and therefore an alternating current (Wilson) Since cell phone batteries need direct current to charge and the receiver coil generates alternating current, a bridge rectifier must be installed. A bridge rectifier is an electrical component that converts alternating current to direct current using a system of four zener diodes connected to each other. This formation of zener diodes causes alternating current to be converted to direct current (Wirelesspowerconsortium.com).

Since the present invention involves inductive coupling, two major factors were considered in its design: coupling factor and the impossibility of using resonant coupling. Coupling factor refers to the significant variation in the quantity of current the receiver coil produces based on the distance between the transmitter and the receiver coils. Coupling is the desirable or undesirable transfer of energy from one medium to another. Coupling is represented by the letter “k” and stretches from a range of 0-1.1. A rating of 0 is attained when the transmitter and receiver coils are too far way for any energy to be transferred. A coupling rating of 1.1 is attained when all of the energy transmitted by the transmitter is received by the receiving coil (i.e., no energy loss). This rating is impossible to achieve due to loss from heat and eddy currents. The concept of coupling factor shows that this device will be most efficient if the cell phones are as close as possible so they have a high coupling factor (Collinson).

Resonant coupling refers to the fact that when the coils are tuned to their resonant frequency, power transfer is significantly more efficient. This was originally discovered by a team of MIT students in 2005. The best design for the device would be to use resonate coupling instead of inductive coupling, however, resonant coupling only works for medium range applications, not short range applications. It is necessary that this device be used at short distances due to the general shape of the magnetic field. Power efficiency would be significantly diminished if the receiver and transmitter coils were not at the exact same angle (e.g., even a variation by 2 degrees causes massive decreased efficiency). It would be unrealistic for users to line their phones up exactly from a medium distance (>1 ft) (Wirelesspowerconsortium.com).

### THE INVENTION

The present invention consists of both a transmitter and receiver circuit that which incorporates the concepts of inductive coupling to wireless transfer electricity between cellular devices and any electrical device that is has a direct current power source. The transmitter circuit converts the direct current power supply from the battery to an alternating magnetic field. The receiver circuit then reacts to the alternating nature of the magnetic field and converts it to direct current. This direct current power source is then used to charge the other cell phone battery. By nature both the receiver and transmitter circuits must be integrated either internally or externally to the cell phone.

### DETAILED DESCRIPTION OF THE REPRESENTATIVE EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

### First Embodiment

By way of example, the present invention may be used to transfer the electrical energy stored in a cell phone battery to other cell phones. For example, if two individuals have two different cell phones (one with a 100% charged battery and another with 0% charged battery), they can't share the power so each can use their device. The device can either be integrated in the interior or exterior of a cell phone. For example, the device could be mounted to be exterior of a phone using a removable phone case. The device could also be integrated within the cell phone itself as on board circuitry.

### Second Embodiment

By way of example, the present invention may be used to transfer electricity between any device that has a direct current power source, this includes but is not limited to cell phones, tablets, laptops, smart watches, etc.

### Definitions

Inductive Coupling—when two conductors are configured such that change in current through one wire induces a voltage across the ends of the other wire through electromagnetic induction.

MOSFET—The metal-oxide-semiconductor field-effect transistor (MOSFET, MOS-FET, or MOS FET) is a type of transistor used for amplifying or switching electronic signals.

Resonant Coupling: Resonant inductive coupling or electrodynamic induction is the near field wireless transmission of electrical energy between two magnetically coupled coils that are part of resonant circuits tuned to resonate at the same frequency.

Wirelessly—refers to the fact that the transmitter and receiver coils are not in direct contact with each other when electrical energy is transferred between them.

Materials (for Constructing Device):
10 k Ohm resistor (2)
2 400V+ rectifiers (2)
12V zener diode (2)
1 uf Tank Capacitor (2)
14 AWG Magnet/enameled (30 ft)
200-400 uH Inductor (1)
2 W 470 ohm resistor (2)
IRFP250 MOSFET (2)
30V+ full wave bridge rectifier
Soldering Iron (1)
Non-lead based solder (1-2 ft.)

Methods (for Constructing Device):
1. Gather materials and preheat soldering iron
2. Construct the transmitter based on the schematic (see FIG. 1)
3. Construct the receiver based on the schematic (see FIG. 2)

Experiment:

Materials—(Displacement and Variation in Input Voltage Experiment):
Device constructed in construction section of materials and methods (1)
Digital Multimeter with the capability of measuring milliamps (1)
Alligator clips (4)
Adjustable Power Supply (1)
12 in. ruler (1)
Tape (2 ft)
8 volt DC fan motor (1)

Methods (Displacement and Variation in Input Voltage Experiment):
1. Tape the metal ruler a unmovable surface, such as a table
2. Tape the transmitter to the unmovable surface in such a fashion that it's coil is at the 0 in. mark of the ruler
3. Connect the Power Supply to the transmitter
4. Using the multimeter measure the initial voltage and current of the power source
   Note: when measuring current, connect the multimeter in series with the circuit
   Note: when measuring voltage, connect the multimeter across the power source (positive node on the positive terminal of the power supply, negative node on the negative terminal of the power supply)
5. Place the receiver coil at the 0.5 in. mark
6. Attach the positive and negative nodes of the multimeter to the positive and negative leads of the full wave bridge rectifier
7. Measure the output voltage of the receiver coil by measuring the voltage across the positive and negative leads of the bridge rectifier
8. Remove the multimeter leads from the bridge rectifier, attach the 8V DC fan, and attach the multimeter in series with the fan and bridge rectifier
9. Measure the output current of the secondary coil by using the multimeter to measure the current in series with the fan and bridge rectifier
10. Repeat steps #6,7,8,9,and 10 except move the receiver 0.5 in on the ruler
   Note: Make sure the receiver coil is at the same angle as the transmitter coil so for the most accurate measurements
11. Repeat set #11 except until the receiver coil no longer receives current or voltage from the transmitter coil
12. Repeat steps #1-12 except increase the input voltage by 0.5V
13. Repeat step #13 until the 8.0V input voltage is reached

Materials—(Axial Displacement Experiment):
1) Device constructed in construction section of materials and methods (1)
2) Digital Multimeter with the capability of measuring milliamps (1)
3) Alligator clips (4)
4) Adjustable Power Supply (1)
5) 12 in. ruler (1)
6) Tape (2 ft)
7) 8 volt DC fan motor (1)

Methods—(Axial Displacement Experiment):
1. Tape the metal ruler and protractor (aligned with 0 in mark on ruler) on an unmovable surface, such as a table
2. Tape the transmitter to the unmovable surface in such a fashion that it's coil is at the 0 in. mark of the ruler and 0° mark on protractor
3. Connect the Power Supply to the transmitter
4. Using the multimeter measure the initial voltage and current of the power source
   Note: when measuring current, connect the multimeter in series with the circuit
   Note: when measuring voltage, connect the multimeter across the power source (positive node on the positive terminal of the power supply, negative node on the negative terminal of the power supply)
5. Place the receiver coil at the 0.5 in. mark and align it with the 0° mark on the protractor
6. Attach the positive and negative nodes of the multimeter to the positive and negative leads of the full wave bridge rectifier
7. Measure the output voltage of the receiver coil by measuring the voltage across the positive and negative leads of the bridge rectifier
8. Remove the multimeter leads from the bridge rectifier, attach the 8V DC fan, and attach the multimeter in series with the fan and bridge rectifier
9. Measure the output current of the receiver coil by using the multimeter to measure the current in series with the fan and bridge rectifier
10. Repeat steps #6,7,8,9, and 10 except increase the axial displacement between the transmitter and receiver coils by 15°
11. Repeat step #10 until the receiver coil is aligned with the 90° mark on the protractor

### Data:

(See FIGS. 3, 4, 5)

### Analysis:

The results showed that inductive coupling has a major impact on power transfer efficiency. Inductive coupling refers to the quantity of magnetic flux that is transferred from the transmitter coil to the receiver coil. This can be increased by increasing the input power, number of coil turns, displacement between coils, and the axial displacement between the coils. This experiment revealed that coupling coefficient and the efficiency of power transfer decrease as the displacement between the coils increases. The reason for this is that the quantity of magnetic flux the receiver coil collects from the transmitter coil decreases as the distance between them increases. Additionally, it revealed that coupling coefficient and efficiency of power transfer decreases when the axial alignment changes between the coils. The reason for this is the quantity of magnetic flux the receiver coil collects is based on the cosine of the axial displacement. Furthermore, it was shown that as the input power increases the coupling and power transfer efficiency increases as well. Since increased input power causes increased magnetic flux to be created by the transmitter coil, more magnetic flux can be collected by receiver coil resulting in increased power efficiency.

The experimental results also proved the concept of coupling factor, as power transfer between the transmitter and receiver dramatically decreased as the displacement between them increased. The reason for this is that the strength of the magnetic field generated by the transmitter coil decreases as the distance from the transmitter increases. This causes the receiver coil receive a lower magnetic field strength and the current output to be decreased.

The device showed little evidence of overheating, which is vital when technology is integrated in cell phones because there is no internal cooling system, such as a fan. Although not tested in this study, the transmitter has the capability to charging more than one cell phone at the same time. This would cause deceased electricity to be transferred to each cell phone because the current would be shared amongst more than one receiver.

The data also displayed a relationship between the efficiency of the device and variation in input power. The data showed that as input power increased, the output power increased and distance the device could transfer energy increased. The reason for this is that as the current flowing into the transmitter's coil increases the magnetic field produced by it increases as well. This causes more energy to be transferred to the receiver coil and greater output power to be formed.

### REFERENCES

### Works Cited

Collinson, Andy. “Coupling Circuits and Techniques.” Coupling Circuits and Techniques. N.p., n.d. Web. 30 Nov. 2014.

Sandler, Steve. “Optimize Wireless Power Transfer Link Efficiency—Part 1.” Power Electronics. N.p., 26 Sept. 2011. Web. 25 Nov. 2014.

Tahsin, Naim Muhammad, Murtoza Siddiqui, Anik Zaman, and Mirza Imrul Kayes. “Wireless Charger for Low Power Devices Using Inductive Coupling.” Academia.edu. N.p., April 2012. Web. 30 Nov. 2014.

Talkingelectronics.com. “The MOSFET.” The MOSFET. N.p., 30 Jul. 2010. Web. 30 Nov. 2014.

Wilson, Tracy V. “Inductive Coupling—How Wireless Power Works.” HowStuffWorks. N.p., 12 Jan. 2007. Web. 30 Nov. 2014.

Wirelesspowerconsortium.com. “Magnetic Resonance and Magnetic Induction—What Is the Best Choice for My Application?” Magnetic Resonance and Magnetic Induction. N.p., n.d. Web. 30 Nov. 2014.

### BRIEF DESCRIPTION OF THE SEVERAL VIEWS OF THE DRAWINGS

FIG. 1: Detailed Schematics of the Present Invention's Transmission Coil Circuit

FIG. 2: Detailed Schematics of the Present Invention's Receiver Coil Circuit

FIG. 3: Graph indicating Power Output of Battery vs Length of Time the Device can be Powered

FIG. 4: Graph indicating The Impact of Coil Displacement on Power Transfer Efficiency

FIG. 5: Graph indicating Impact of Angular Alignment between Coils on Power Transfer Efficiency

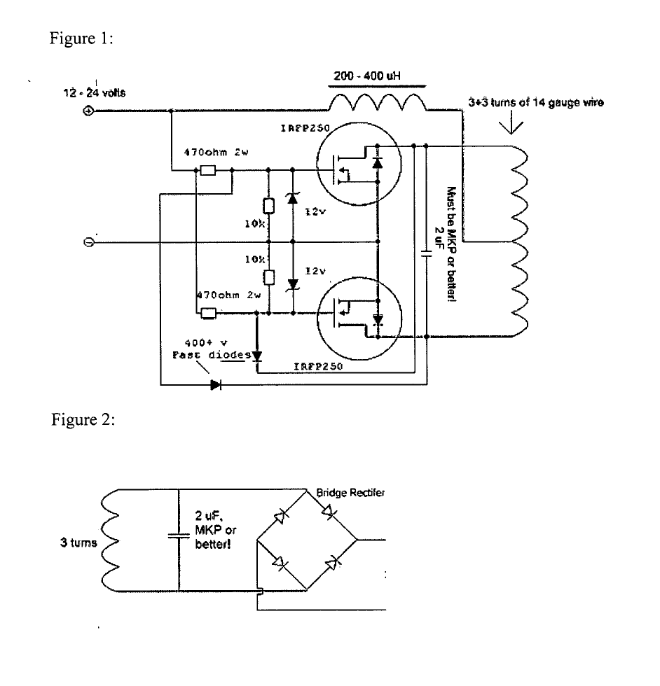

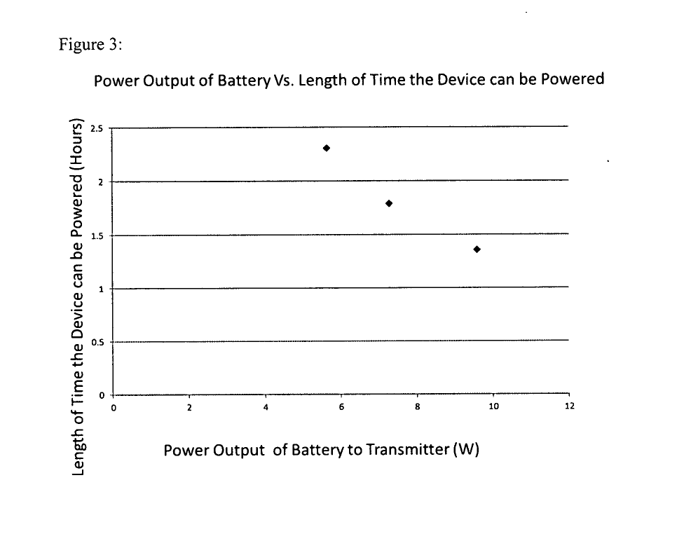

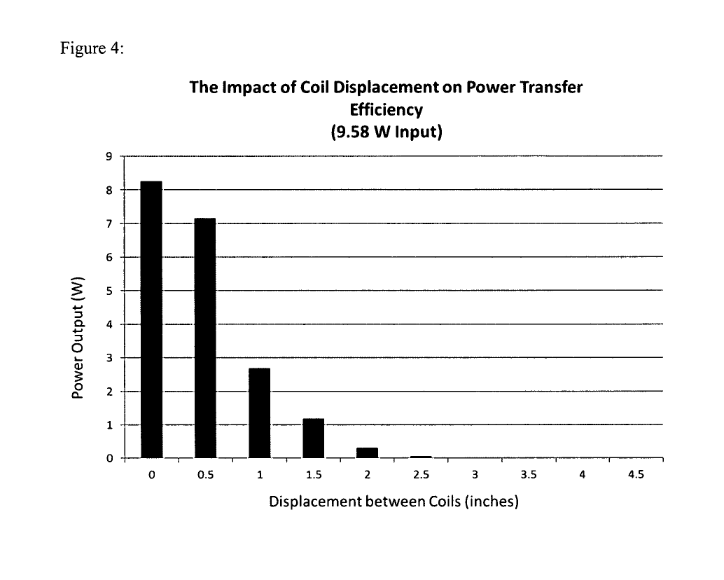

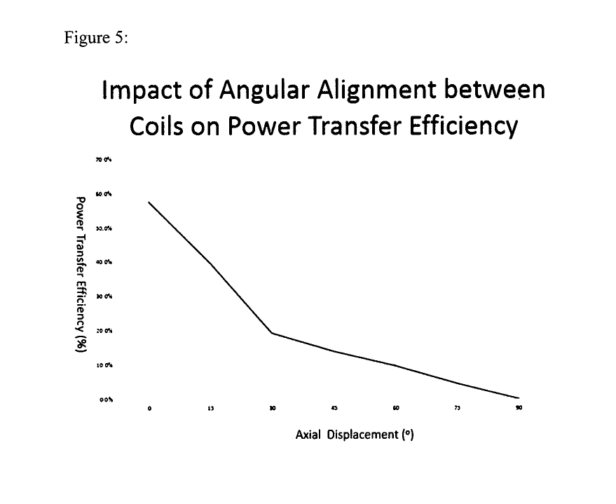

1) A device either internally or externally integrated within cellphones or other electrical devices that use a direct current power source to wirelessly transfer electricity between two or more cellphones.

2) The device can either be attached internally (i.e. integrated into the cellphone's circuity) or externally (i.e. a removable cell phone case)
